(19) United States
(12) Patent Application Publication
(10) Pub. No.: US 2009/0057231 A1
(43) Pub. Date: Mar. 5, 2009

(54) MONODISPERSE BORON-SELECTIVE RESINS

(75) Inventors: Michael Schelhaas, Koln (DE); Pierre Vanhoorne, Monheim (DE); Olaf Halle, Koln (DE); Stefan Neumann, Leverkusen (DE)

Correspondence Address: LANXESS CORPORATION, 111 RIDC PARK WEST DRIVE, PITTSBURGH, PA, 15275-1112, US

(73) Assignee: LANXESS Deutschland GmbH, Leverkusen (DE)

(21) Appl. No.: 12/193,218

(22) Filed: Aug. 18, 2008

(30) Foreign Application Priority Data
Aug. 29, 2007 (DE) 102007040764.7

(51) Int. Cl. C02F 1/42; B32B 15/02

(52) U.S. Cl. 210/681; 428/407

(57) ABSTRACT

The present invention relates to macroporous, monodisperse boron-selective ion exchangers having improved boron uptake kinetics and improved boron capacity, containing N-methylglucamine structures, having a median diameter D between 550 and 750 μm and a volumetric fraction of beads between 0.9 D and 1.1 D of at least 75%.

The present invention relates to monodisperse boron-selective resins containing N-methylglucamine structures and also the use thereof for removing boron from liquids.

### BACKGROUND OF THE INVENTION

Ion exchangers are used in many fields such as, for example for softening water, for desalination and purification of aqueous solutions, for separating off and purifying sugar solutions and amino acid solutions and for preparing high purity water in the electronics and pharmaceutical industry. However, conventional ion exchangers can to only take up compounds which are difficult to ionize, such as, for example, silicon dioxide and boric acid, with limitations.

Because of its toxicity, boric acid and/or borate must only be present in traces in drinking water. If it is wanted to obtain drinking water from seawater, as is desirable in many regions of the world, this is a particular problem. Seawater contains many times the maximum permissible concentration of boric acid and/or borate for drinking water and the techniques for desalinating seawater (reverse osmosis, conventional ion exchangers) are not able to lower this concentration to the range acceptable for drinking water.

In the electronics industry also, boric acid or borate is undesirable since the element boron is used for doping semiconductors. In the production process of silicon chips, they must be cleaned with water after various chemical reactions. Here, traces of boron in the form of boric acid and/or borate, even in the ppb range, markedly increase the number of faulty chips. Again, the conventional ion exchangers are not able to guarantee boric acid or borate concentrations in the sub-ppb range.

In order to meet the requirements of these fields of application, resins are needed which are able to take up boric acid and/or borate. In the case of drinking water preparation from seawater, these resins shall preferentially take up boric acid or borate (boron-selective resins), in order that other ions such as sodium, magnesium, calcium, chloride, nitrate, sulfate, which must remain in certain amounts in the drinking water are not taken up together with, or even preferentially additionally to, boric acid and/or borate.

In addition, the resins must possess very high uptake kinetics for boric acid or borate. In the case of drinking water preparation, large volumes of water must be provided in a short time which leads to very high flow rates of water through the ion exchange bed. In the case of the electronics industry, the very low concentrations of boric acid or borate reduce the frequency of contacts between boric acid/borate and boron-selective groups dramatically.

In order to be able to operate efficiently, each such contact must lead to the immediate uptake of boric acid or borate.

Finally, the resins must be able to take up significant amounts of boric acid or borate per unit volume of resin in order to avoid a frequent change of resin.

Boron-selective resins are already described in the patent literature. For instance, U.S. Pat. No. 3,567,369 and DD 279 377, for example, mention the production of boron-selective resins by reacting chloromethylated styrene/divinylbenzene polymer beads with sugar derivatives.

Although these resins are boron-selective, they are distinguished, especially in the range of ultrapure water (UPW), by unsatisfactory uptake kinetics and by low uptake capacity for boron.

JP 2002226517 A claims boron-selective resins having a median diameter<450 μm and a narrow particle size distribution. These resins, in comparison with the conventional boron-selective resins, exhibit an improved uptake capacity for boron which is still, however, inadequate for many uses. In addition, such resins having a small bead diameter lead to a higher pressure drop in the columns which is disadvantageous for applications where large amounts of water must be treated such as, for example, the desalination of seawater.

Therefore, for water preparation, there is a requirement for boron-selective ion exchangers having a high capacity and outstanding uptake kinetics.

It has now surprisingly been found that, contrary to the teaching of JP 2002226517, such resins can be synthesized by the combination of porosity, monodispersity and median diameter between 550 and 750 μm and lead to markedly better adsorption rates for boron.

### SUMMARY OF THE INVENTION

The present invention therefore relates to macroporous, monodisperse ion exchangers for the selective adsorption of boron which contain N-methylglucamine structures and have a median diameter D between 550 and 750 μm and also a volumetric fraction of at least 75% of the beads between 0.9 D and 1.1 D, where the monodispersity is achieved by sieving heterodisperse resins, by jetting methods, or by seed-feed methods.

Boron and boron selective for the purposes of the present invention means boric acid or salts thereof with alkali metals or alkaline earth metals (borates), preferably with sodium, potassium, or magnesium, and selective for these compounds, respectively.

For production of the boron-selective ion exchangers of the invention which contain N-methylglucamine structures, preferably, first non-functionalized polymer beads are generated by suspension polymerization of non-functionalized monomers and these are given N-methylglucamine structures in one or more downstream step(s).

As non-functionalized monomers, use is generally made of monoethylenically unsaturated aromatic monomers, preferably styrene, methylstyrene, vinyltoluene, t-butylstyrene or vinylnaphthalene. Very suitable substances are also mixtures of these monomers and also mixtures of monoethylenically unsaturated aromatic monomers having up to 20% by weight of other monoethylenically unsaturated monomers, preferably chlorostyrene, bromostyrene, acrylonitrile, methyl acrylonitrile, esters of acrylic acid or methacrylic acid such as methyl methacrylate, ethyl methacrylate, methyl acrylate, ethyl acrylate, isopropyl methacrylate, butyl acrylate, butyl methacrylate, hexyl methacrylate, 2-ethylhexyl acrylate, ethylhexyl methacrylate, decyl methacrylate, dodecyl methacrylate, stearyl methacrylate, or isobornyl methacrylate. In particular, preference is given to styrene and vinyltoluene.

Crosslinkers are added to the monomers. Crosslinkers are generally multiethylenically unsaturated compounds, preferably divinylbenzene, divinyltoluene, trivinylbenzene, ethylene glycol dimethacrylate, ethylene glycol diacrylate, ethylene glycol divinyl ether, diethylene glycol divinyl ether, butanediol divinyl ether, octadiene or triallyl cyanurate. Particular preference is given to the vinylaromatic crosslinkers divinylbenzene or trivinylbenzene. Very particular preference is given to divinylbenzene. The crosslinkers can be used alone or as a mixture of different crosslinkers. The total amount of crosslinkers to be used is generally 0.1 to 80% by weight, preferably 0.5 to 60% by weight, particularly preferably 1 to 40% by weight, based on the sum of the ethylenically unsaturated compounds.

To generate the pore structure in the non-functional polymer beads, pore forming agents, termed porogens, are added to the monomers. As porogens, use is preferably made of organic diluents. Particularly preferably, use is made of those organic diluents which dissolve to less than 10% by weight, preferably less than 1% by weight, in water. Especially suitable porogens are toluene, ethylbenzene, xylene, cyclohexane, octane, isooctane, decane, dodecane, isododecane, methyl isobutyl ketone, ethyl acetate, butyl acetate, dibutyl phthalate, n-butanol, 4-methyl-2-pentanol and n-octanol. Very particular preference is given to toluene, cyclohexane, isooctane, isododecane, 4-methyl-2-pentanol and methyl isobutyl ketone.

As porogen, use may, however, also be made of noncrosslinked, linear or branched polymers, preferably polystyrene and poly(methyl) methacrylate.

The porogen is conventionally used in amounts of 10 to 200% by weight, preferably 25 to 150% by weight, particularly preferably 40 to 100% by weight, in each case based on the sum of the ethylenically unsaturated compounds.

In the production of the non-functional polymer beads, the abovementioned monomers, in a further preferred embodiment of the present invention, are polymerized in the presence of a dispersant using an initiator in aqueous suspension.

As dispersant, use is preferably made of natural or synthetic water-soluble polymers. Particular preference is given to using gelatin, starch, poly(vinyl alcohol), poly(vinyl-pyrrolidone), poly(acrylic acid), poly(methacrylic) acid or copolymers of (meth)acrylic acid or (meth)acrylic esters. Very particular preference is given to using gelatin or cellulose derivatives, in particular cellulose esters or cellulose ethers, in particular particularly preferably carboxymethylcellulose, methylcellulose, hydroxyethyleellulose or methylhydroxyethylcellulose. The usage rate of the dispersant is generally 0.05 to 1%, preferably 0.1 to 0.5%, based on the water phase.

In a further preferred embodiment of the present invention initiators are used. Suitable initiators are compounds which form free radicals on temperature elevation. Preferably, use is made of peroxy compounds, particularly preferably dibenzoyl peroxide, dilauryl peroxide, bis(p-chlorobenzoyl) peroxide, dicyclohexyl peroxydicarbonate and tert-amylperoxy-2-ethylhexane and also azo compounds, particularly preferably 2,2′-azobis(isobutyronitrile) or 2,2′-azobis(2-methylisobutyronitile) or else aliphatic peroxy esters, preferably tert-butyl peroxyacetate, tert-butyl peroxyisobutyrate, tert-butyl peroxypivalate, tert-butyl peroxyoctoate, tert-butyl peroxy-2-ethylhexanoate, tert-butyl peroxyneodecanoate, tert-amyl peroxypivalate, tert-amyl peroxyoctoate, tert-amyl peroxy-2-ethylhexanoate, tert-amyl peroxyneodecanoate, 2,5-bis(2-ethyl-hexyanoylperoxy)-2,5-dimethylhexane, 2,5-dipivaloyl-2,5-dimethylhexane, 2,5-bis-(2-neodecanoylperoxy)-2,5-dimethylhexane, di-tert-butyl peroxyazelate and di-tert-amyl peroxyazelate.

When initiators are used these are generally used in amounts of 0.05 to 6.0% by weight, preferably 0.1 to 5.0% by weight, particularly preferably 0.2 to 2% by weight, based on the sum of the ethylenically unsaturated compounds.

The water phase can if appropriate contain a buffer system which sets the pH of the water phase to a value between 12 and 3, preferably between 10 and 4. Particularly highly suitable buffer systems contain phosphate salts, acetate salts, citrate salts or borate salts.

It can be advantageous to use an inhibitor dissolved in the aqueous phase. Inhibitors to be used optionally which come into question are not only inorganic but also organic substances. Preferred inorganic inhibitors are nitrogen compounds, particularly preferably hydroxylamine, hydrazine, sodium nitrite or potassium nitrite. Preferred organic inhibitors are phenolic compounds, particularly preferably hydroquinone, hydroquinone monomethyl ether, resorcinol, pyrocatechol, tert-butylpyrocatechol or condensation products of phenols with aldehydes. Further preferred organic inhibitors are nitrogenous compounds, particularly preferably diethylhydroxylamine or isopropylhydroxylamine. Resorcinol is especially preferred as inhibitor. The concentration of the optionally used inhibitor is 5-1000 ppm, preferably 10-500 ppm, particularly preferably 20-250 ppm, based on the aqueous phase.

The organic phase can be dispersed as droplets by agitation or by jetting into the aqueous phase. Organic phase is taken to mean the mixture of monomer(s), crosslinker(s), porogen(s) and initiator(s). In classic dispersion polymerization, the organic droplets are generated by agitation. On the 4 liter scale, typically agitator speeds of 250 to 400 rpm are used. If the droplets are generated by jetting, it is advisable, for maintenance of uniform droplet diameter, to encapsulate the organic droplets. Methods of microencapsulation of jetted organic droplets are described, for example, in EP-A 0 046 535, the content of which with respect to microencapsulation is hereby incorporated by the present application.

The median diameter of the optionally encapsulated monomer droplets is 10-1000 μm, preferably 100-1000 μm.

The ratio of the organic phase to the aqueous phase is generally 1:20 to 1:0.6, preferably 1:10 to 1:1, particularly preferably 1:5 to 1:1.2.

However, the organic phase can also, in what is termed the seed-feed method, be added to a suspension of seed polymers which take up the organic phase, as claimed in EP-A 0 617 714, the teaching of which is incorporated by the present application. The median diameter of the seed polymers swollen by the organic phase is 5-1200 ™m, preferably 20-1000 μm. The ratio of the sum of organic phase+seed polymer to the aqueous phase is generally 1:20 to 1:0.6, preferably 1:10 to 1:1, particularly preferably 1:5 to 1:1.2.

The polymerization of the monomers is carried out at elevated temperature. The polymerization temperature depends on the decomposition temperature of the initiator and is typically in the range from 50 to 150° C., preferably 60 to 120° C. The polymerization time is 30 minutes to 24 hours, preferably 2 to 15 hours.

At the end of the polymerization, the non-functional polymer beads are separated off from the aqueous phase, for example on a vacuum filter, and optionally dried.

The conversion of the polymer beads to give a boron-selective ion exchanger containing N-methylglucamine structures can proceed via chloromethylation and subsequent amination with N-methylglucamine.

For the chloromethylation, use is preferably made of chloromethyl methyl ether. The chloromethyl methyl ether can be used in unpurified form, wherein, as minor components, it can contain, for example, methylal and methanol. The chloromethyl methyl ether is preferably used in excess and acts not only as reactant but also as solvent and swelling agent. The use of an additional solvent is therefore not generally necessary. The chloromethylation reaction is catalyzed by addition of a Lewis acid. Preferred catalysts are iron (III) chloride, zinc chloride, tin (IV) chloride or aluminum chloride. The reaction temperature can be in the range from 40 to 80° C. In the case of an unpressurized procedure, a temperature range of 50 to 60° C. is particularly favorable. During the reaction the volatile components such as hydrochloric acid, methanol and methylal are removed by vaporization. For removal of the residual chloromethyl methyl ether, and also for purification of the chloromethylate, the mixture can be washed with methylal, methanol and finally with water.

Further methods of chloromethylation of polymer beads are described, for example, in DD 250 129 AI and EP-A 1 273 435.

For production of the boron-selective ion exchangers, the chloromethylated copolymer is reacted with N-methylglucamine.

For complete conversion of the chloromethylated copolymer, at least 1 mol of N-methylglucamine, based on 1 mol of chlorine in the chloromethylate, are required. Preference is given to an N-methylglucamine excess of 1.05 to 5 mol of amine per mol of chlorine. Particular preference is given to 1.1 to 2.5 mol of N-methylglucamine per mot of chlorine.

The amination reaction proceeds in the presence of a suitable solvent. Preference is given to solvents which swell the chloromethylated copolymer and at the same time dissolve the N-methylglucamine at more than 100 g per liter. Particularly preferred solvents are dimethylformamide, dimethyl sulfoxide or mixtures of water with C1-C3 alcohols. Very particular preference is given to dimethylformamide, water/methanol or water/ethanol mixtures.

During the amination the resin swells. Therefore, a minimum amount of solvent is necessary in order to keep the batch stirrable. Per gram of chloromethylated polymer beads, use is preferably made of at least 2 gram, particularly preferably 2.5 to 5 gram, of solvent.

The temperature at which the amination is carried out can be in the range between room temperature and 160° C. Preferably, use is made of temperatures between 70 and 120° C., particularly preferably in the range between 70 and 110° C.

After the amination, the resulting anion exchanger is washed with deionized water at temperatures of 20 to 120° C., preferably 50 to 90° C. The product is isolated, for example, by settling or filtration.

The monodispersity required according to the invention can be achieved in a preferred embodiment of the present invention by sieving conventional ion exchangers containing N-methylglucamine groups, that is to say produced by suspension polymerization with stirring.

In a further preferred embodiment of the present invention, a monodisperse, crosslinked vinylaromatic base polymer can be produced by the methods known from the literature. For example, such methods are described in U.S. Pat. No. 4,444,961. EP-A 0 046 535, U.S. Pat. No. 4,419,245 or WO 93/12167, the contents of which in this respect are hereby incorporated in their entirety by the present application.

Particularly preferably according to the invention, monodisperse polymer beads and the monodisperse ion exchangers containing N-methylglucamine groups to be prepared therefrom are obtained by jetting or seed-feed methods.

The monodisperse, boron-selective resins according to the invention have a median diameter D between 550 μm and 750 μm. For determination of the median diameter and the particle size distribution, conventional methods such as sieving analysis or image analysis are suitable. The median diameter D, for the purposes of the present invention, is taken to mean the 50% value (Ø (50)) of the volume distribution. The 50% value (Ø (50)) of the volume distribution gives the diameter below which 50% by volume of the particles fall.

In contrast to the heterodisperse particle size distribution known from the prior art, in the present application, particle size distributions are termed monodisperse in which at least 75% by volume, preferably at least 85% by volume, particularly preferably at least 90% by volume, of the particles have a diameter which is in the interval having the width of ±10% of the median diameter about the median diameter.

For example, in the case of polymer beads having a median diameter of 0.5 mm, at least 75% by volume, preferably at least 85% by volume, particularly preferably at least 90% by volume, are in a size interval between 0.45 mm and 0.55 mm, in the case of a substance having a median diameter of 0.7 mm, at least 75% by volume, preferably at least 85% by volume, particularly preferably at least 90% by volume, are in a size interval between 0.77 mm and 0.63 mm.

The monodisperse, boron-selective resins according to the invention have a macro-porous structure. A macroporous structure, for the purposes of the present invention, is taken to mean according to the IUPAC a structure having pores which have a median diameter greater than 50 nm. Preferably, the macroporous, boron-selective resins according to the invention have a total pore volume, measured on the dried resin using the method of mercury intrusion porosimetry, of at least 0.1 cm3/g, particularly preferably at least 0.5 cm3/g.

The ion exchangers according to the invention are outstandingly suitable for adsorption of boron from liquids, preferably from drinking water, seawater or process water, in or from the electronics industry.

It will be understood that the specification and examples are illustrative but not limitative of the present invention and that other embodiments within the spirit and scope of the invention will suggest themselves to those skilled in the art.

### EXAMPLES

### Example 1

### Production of a Heterodisperse, Macroporous, Boron-Selective Resin as Per JP 20022265 17 (Prior Art, not According to the Invention)

339 g of water-wet, heterodisperse chloromethylated polymer beads (water content 25% by weight), 1407 g of ethanol, 500 g of N-methyl-D-glucamine and 428 g of water were charged into a 5 liter pressure reactor. The reactor was closed and its contents heated in the course of 1.5 h to 90° C. The reaction mixture was agitated at 90° C. for 12 h and subsequently cooled. The aminated product was filtered off by suction, washed two times with 2 liters of deionized water, once with 2 liters of 5% strength sulfuric acid and again with 4 liters of deionized water. This produced 880 ml of a water-wet heterodisperse, macroporous boron-selective resin.

Subsequently, the fraction between 355 and 450 μm was sieved out from the resin.

This produced a boron-selective resin as per JP 2002226517 having the following characteristics:

Median diameter D: 420 μm

Volumetric fraction of beads between 0.9 D and 1.1 D: 65% between 378 μm and 462 μm.

### Example 2

### Production of a Monodisperse, Macroporous, Boron-Selective Resin (According to the Invention)

### 2a) Production of Monodisperse, Macroporous Polymer Beads

3000 g of deionized water were charged into a 10 l glass reactor and a solution of 10 g of gelatin, 16 g of disodium hydrogenphosphate dodecahydrate and 0.73 g of resorcinol in 320 g of deionized water were added and mixed thoroughly. The mixture was heated to 25° C. With stirring, a mixture of 3200 g of microencapsulated monomer droplets having a narrow particle size distribution which was obtained by jetting from 3.6% by weight divinylbenzene and 0.9% by weight ethylstyrene (used as conventional mixture of isomers of divinylbenzene and ethylstyrene with 80% divinylbenzene), 0.5% by weight dibenzoyl peroxide, 56.2% by weight styrene and 38.8% by weight isododecane (technical mixture of isomers having a high content of pentamethylheptane) was subsequently added, wherein the microcapsules consisted of a formaldehyde-cured complex coacervate of gelatin and a copolymer of acrylamide and acrylic acid, and 3200 g of aqueous phase having a pH of 12 were added. The median diameter of the monomer droplets was 460 μm.

The batch was polymerized to completion with stirring by temperature elevation according to a temperature program starting at 25° C. and ending at 95° C. The batch was cooled, washed over a 32 μm sieve and subsequently dried in vacuum at 80° C. This produced 1893 g of a spherical polymer having a median diameter of 440 μm, narrow particle size distribution and smooth surface.

The polymer beads were chalky white in appearance and had a bulk density of approximately 370 g/l.

2b) Chloromethylation of the Monodisperse, Macroporous Polymer Beads from 2a)

1120 ml of a mixture of monochlorodimethyl ether, methylal and iron (III) chloride (14.8 g/l) were charged into a 2 liter sulfonation flask and subsequently 240 g of polymer beads from 2a) were added. The mixture was heated to 50° C. and agitated for 6 h under reflux in the range 50-55° C. During the reaction time hydrochloric acid and low-boiling organic substances were expelled or distilled off, Subsequently, the reaction suspension was washed intensively with, successively, 1200 ml of methanol, 2400 ml of methylal, 3 times with 1200 ml of methanol and finally with deionized water. This produced 590 ml of water-wet, monodisperse, macroporous chloro-methylated polymer beads having a chlorine content of 20.1% by weight.

2c) Conversion of the Monodisperse, Chloromethylated, Macroporous Polymer Beads from 2b) to Give a Monodisperse, Macroporous, Boron-Selective Resin

339 g of the water-wet chloromethylated polymer beads from 2b) (water content 25% by weight), 1407 g of ethanol, 500 g of N-methyl-D-glucamine and 428 g of water were charged into a 5 liter pressure reactor. The reactor was closed and its contents were heated in the course of 1.5 h to 90° C. The reaction mixture was agitated for 12 h at 90° C. and subsequently cooled. The aminated product was filtered off by suction, washed twice with 2 liters of deionized water, once with 2 liters of 5% strength by weight sulfuric acid and again with 4 liters of deionized water. This produced 880 ml of a water-wet monodisperse, macroporous boron-selective resin.

Amount of weakly basic groups per liter of resin: 0.87 mol.

Median diameter D: 572 μm

Volumetric fraction of beads between 0.9 D and 1.1 D: 87% between 515 μm and 629 μm

### Example 3

### Determination of Boron Uptake Kinetics of the Boron-Selective Resins

Each resin available for study was treated as follows:

100 ml of resin in a column were eluted successively with 500 ml of 6.5% strength by weight hydrochloric acid, 500 ml of deionized water, 500 ml of 4% strength by weight sodium hydroxide solution and 500 ml of deionized water.

After removal from the column, the resin was shaken to constant volume. 20 ml thereof were sucked dry using a suction tube and charged into a 1 liter glass beaker equipped with agitator device.

Thereafter the agitator was switched on at a constant speed of 175 rpm.

Subsequently, 500 ml of a boron solution (content 2.5 g of boric acid per liter) were swiftly added thereto.

Then, in each case 10 ml samples of the solution were taken after the following agitation times: 0; 0.5; 1; 2; 5; 10; 20; 30; 60; 1200 minutes.

The boron content of each solution thus taken was determined analytically. From the boron content of the solution at a given timepoint, the amount of boron taken up per liter of resin was calculated. For the resins from examples 1 and 2, this gave the values of table 1.

TABLE 1
Boron uptake kinetics of the boron-selective
resins from examples 1 and 2

| | Amount of boric acid taken up | |
|---|---|---|
| | (g of boron per liter of resin) | |
| Time | | |
| (min) | Example 1 (prior art) | Example 2 (according to the invention) |
| 0.5 | 2.75 | 2.84 |
| 1 | 4.42 | 4.42 |
| 2 | 5.29 | 5.16 |
| 5 | 6.43 | 6.21 |
| 10 | 7.26 | 7.35 |
| 20 | 7.48 | 8.31 |
| 30 | 7.52 | 8.88 |
| 60 | 7.91 | 9.05 |
| 1200 | 8.04 | 9.01 |

It is seen that the resin according to the invention, compared with the prior art, had a higher boron uptake capacity and improved boron uptake kinetics. After 30 minutes of contact time with the boron solution, the resin according to the invention has already achieved 99% of its capacity of 9 g of boron per liter of resin, wherein the prior art resin had achieved only 93% of its lower capacity of 8 g per liter of resin. In other words the resin according to the invention, after 30 minutes, exhibited a performance which was 20% improved compared with the prior art.

Deionized water for the purposes of the present invention has a conductivity of 0.1 to 10 μS, wherein the content of soluble metal ions is no greater than 1 ppm, preferably no greater than 0.5 ppm, for Fe, Co, Ni, Mo, Cr, Cu as individual components and is no greater than 10 ppm, preferably no greater than 1 ppm, for the sum of said metals.

1. An ion exchanger, comprising:
as part of the chemical structure thereof, N-methylglucamine, and
further wherein said ion exchanger is in the form of polymer beads having a median diameter, D, of between 550 and 750 μm and a volumetric fraction of at least 75% of the beads between 0.9 D and 1.1 D, wherein said ion exchanger is monodisperse and wherein the monodispersity is achieved by sieving heterodisperse resins, by jetting methods, or by seed-feed methods.

2. The ion exchanger according to claim 1, wherein said ion exchanger has a total pore volume of at least 0.1 cm³/g.

3. A method for the selective adsorption of boron from a boron-containing composition, comprising:
contacting the ion exchanger according to claim 1 with said boron-containing composition.

4. The method according to claim 3, wherein the boron-containing composition is in liquid form.

5. The method according to claim 4, wherein the liquid is selected from the group consisting of drinking water, seawater and process water, said process water being part of or from the electronics industry.

6. The method according to claim 3, wherein the boron is in the form of boric acid or salts thereof with alkali metals or alkaline earth metals.
